(19) United States
(12) Patent Application Publication
(10) Pub. No.: US 2012/0203572 A1
(43) Pub. Date: Aug. 9, 2012

(54) MERCHANTSELLECT POINT-OF-ENTRY KIOSK LOYALTY SYSTEM & PREPAID CARD DEPOSIT AND LOYALTY KIOSK DEVICE

(76) Inventor: Scott Christensen, Omaha, NE (US)

(21) Appl. No.: 13/366,406

(22) Filed: Feb. 6, 2012

Related U.S. Application Data
(60) Provisional application No. 61/439,959, filed on Feb. 7, 2011.
(60) Provisional application No. 61/511,176, filed on Jul. 25, 2011.

(51) Int. Cl. G06Q 30/02; G06Q 50/24; G06Q 50/22

(52) U.S. Cl. 705/3; 705/14.49; 705/14.65; 705/2

(57) ABSTRACT

A Point-of-Entry Kiosk loyalty system, couponing system, and shopping list system is provided so when a consumer enters a store, kiosk(s)s may be present for consumer check-in. When at or within proximity of the kiosk (e.g., from an RFID enabled cell phone) the consumer may log in or be recognized. The consumer may swipe a coded loyalty card, enter their loyalty number or data may be automatically entered through RFID technology or smart phone. The consumer may be presented with discount or coupon offers or shopping suggestions, which may be based on the consumer's prior preferences, demographic data, prior purchases, or preference data harvested from various social networking sites, search engines, or other websites used by the consumer.

### CROSS-REFERENCE TO RELATED APPLICATIONS

The present application claims priority Provisional Patent Application Ser. No. 61/439,959, filed Feb. 7, 2011, and Provisional Patent Application Ser. No. 61/511,176, filed Jul. 25, 2011, both of which are incorporated herein by reference.

### FIELD OF THE INVENTION

The present invention relates to a point of entry (POE) customer loyalty system. In particular, the present invention is directed toward a kiosk or other system for alerting consumers of promotional items of interest, coupons or discounts available, or shopping list reminders, either through a kiosk or through a smart phone or other consumer device, which provides the consumer with the discount, coupons, promotional items, or shopping lists at the point of entry or during the shopping experience, before the point of sale (POS) checkout process. In a second embodiment, the Kiosk provides for transfer of funds by accepting currency or checks and depositing on to and/or dispensing a prepaid card for the unbanked consumer. The MerchantSellect prepaid card also functions as a loyalty card for merchants offering the prepaid kiosk.

### BACKGROUND OF THE INVENTION

Coupons and other incentives to promote consumption, steer consumers to specific brands, and increase sales, have been used for decades. In recent years, coupons have moved online, with the present inventor being one of the pioneers in this field.

Christensen, U.S. Pat. No. 6,035,280 issued Mar. 7, 2000 and incorporated herein by reference, discloses an electronic discount couponing method and apparatus for generating an electronic list of coupons. Christensen, U.S. Pat. No. 5,710,886 issued Jan. 20, 1998 and incorporated herein by reference, discloses an electric couponing method and apparatus. Christensen, published U.S. Patent Application No. 2003/00888461, published May 8, 2003 and incorporated herein by reference, discloses a virtual couponing method and apparatus for use with a consumer kiosk.

The aforementioned Christensen Patents and published application are assigned to Catalina Marketing of St. Petersburg, Fla. Catalina is a leader in marketing Point of Sale (POS) couponing systems. These types of systems are well-known in the art and generate coupons at the point of sale, often based upon or triggered by, a consumer's purchase. Thus, for example, if a consumer purchases a pet food product, a coupon printing machine attached to the cash register may print out a coupon for a pet-related item, for the consumer to use during his next shopping trip.

While this type of POS couponing has met with some success, there are a number of difficulties with it. Since the coupons are presented at the Point of Sale (POS) and not the point of entry (POE), the consumer receives them after having completed their shopping, not before. As a result, the consumer is not being prompted to consume, or steered toward a particular brand during the shopping trip, but at the end of it. The consumer has to remember to retain the coupon and remember to bring it with them during the next visit, otherwise the marketing opportunity is lost. And since many consumers do not use coupons, most POS coupons are discarded, rather than being used. Thus, the redemption rate for such coupons remains low. Those redeeming the coupons may tend to be more bargain-conscious consumers (e.g., couponers and the like) and may not be representative of the general public. Thus, demographic data obtained from coupon redemption may be skewed. Moreover, marketing efforts may be limited to a lower-than-average income demographic. The Prepaid Loyalty Kiosk appeals to the lower income demographic that is often unbanked by offering a low cost prepaid card. The MerchantSellect prepaid card also integrates into a retailer's established loyalty program offering value add to the prepaid card.

The POS coupon, however, was a first step toward gearing coupons toward consumer interests—by monitoring what a consumer bought, it is easier and more effective to generate coupons “of interest” to a particular consumer. Mailing or generating coupons for baby food or disposable diapers to consumers without infant children is wasteful, as it mailing or generating coupons for dog food to consumers have cats—or no pets at all. Internet couponing, pioneered by the present inventor, addressed this problem, in that an online or other electronic delivery system for coupons at least allows the user to select from coupons of interest, without wasting paper or postage generating physical coupons, which are not of interest. Moreover, electronic couponing allows for targeting of coupon or promotional offers to consumers based on demographic data and consumption patterns before the shopping experience, not afterwards at the Point of Sale.

Many retail outlets now have loyalty cards or other loyalty systems whereby a consumer may register with the retailer to receive loyalty rewards, discounts, coupons, cash back, or other savings, based on purchases made at the retailer. The consumer is given a bar-coded card/Mag Stripe and/or key fob with an identifying number, and discounts are applied at the time of purchase, or are applied at the next purchase, or are given in the form of rebates or other promotions. If the consumer fails to bring the card with them, often, the cashier can “look up” the consumer's loyalty number by phone number, usually cell phone number. And increasingly, many stores are just using the consumer's phone number as the loyalty membership number, to reduce or eliminate the need for a bar-coded/Mag Stripe card or key fob.

Loyalty programs have met with some limited success, but have difficulties of their own. For example, if a consumer visits even a half-dozen retailers with such loyalty programs, they end up with a wallet full of loyalty cards or a key chain clogged with loyalty fobs. For that reason alone, many retailers are moving to a phone-number based loyalty program. Moreover, most loyalty programs fail to live up to their full potential, in terms of providing the consumer with significant discounts or providing the retailer with significant advantage from the program. Due to the large numbers of programs, many consumers may fail to take advantage of discounts offered or rebates or credits (e.g., for pennies off on gasoline, based on food purchases) which may require visiting a website or keeping track of credits or redeeming points. Moreover, many cashiers may scan their own loyalty reward card, either to be helpful for a customer who forgot theirs, or to surreptitiously redirect rewards credits from customer purchases to their own accounts—thus negating any demographic data harvesting efforts.

But like POS couponing, rewards cards and programs tend to offer rewards at the end of the shopping experience, and thus are not as effective in steering customers toward purchasing certain goods or in encouraging impulse consumption. Many shoppers choose products based on criteria other than price or offered discounts. Thus, offering “rewards” bonuses at checkout are merely an unexpected benefit to such consumers. Or, if the consumer is choosing a product based on an advertised rewards program discount (e.g., via aisle card) they are doing little more than price comparison shopping, which is subtly different from couponing. The reward or discount is effectively wasted on that consumer as it was not used as a means of guiding their shopping experience, but rather was just an ancillary rebate or discount.

A better approach to post hoc couponing or rewards at the cash register may be to provide coupon or rewards incentives before the consumer starts shopping—to direct or guide the consumer's shopping experience before hand. Traditional paper coupons and the present inventor's pioneering Internet Couponing techniques provided the consumer with shopping direction, in the form of coupon discounts, before the consumer commenced shopping.

Wholesale shopping clubs and some retail grocery chains and other types of stores sometimes offer coupons in sheet or booklet form, in a display or kiosk as the consumer enters the store. These types of coupons are more readily used by consumers, as they do not need to “remember” to bring coupons with them, and thus the bargains or discounts are available to all. However, they do require that the consumer go through a list of coupons on sheets or booklets, and again, many of these coupons may be of no interest to the consumer. And moreover, such coupons are not tied directly to consumer demographic data.

However, traditional paper coupons and even Internet coupons do require the consumer to make a conscious choice to search out and collect coupons prior to going to the store or while in the store isle. Many cost-conscious consumers will collect coupons, whether paper or Internet-based, and plan their shopping experience accordingly. Such cost-conscious consumers represent a minority of consumers and moreover do not represent the more lucrative market segments—more affluent consumers who are less cost-conscious and may not be inclined to clip coupons and collect them, as they may view such activities as time consuming and not worthwhile. A technique is needed in the art to target consumers in these higher income brackets.

Few consumers use shopping lists in their shopping, which may represent lost revenue for a retailer. Many affluent consumers do not feel they have time to prepare shopping lists—which represents a loss for both retailer and consumer. For example, if a shopper goes to a large grocery chain without a shopping list, they may forget to purchase one or more items. As a result, those items may be purchased later on, at a higher cost to the consumer, from a local grocery store or convenience store. Such forgotten purchases represent a lost sale for the large grocery chain store and an increased purchase cost to the consumer, when purchasing the “forgotten” item at a convenience store. A need exists in the art for a means to provide consumers, particularly affluent, busy consumers, with a shopping list or guide that will help them remember to purchase all needed items and thus maximizing sales opportunities for the retailer.

The aforementioned Christensen Application, published U.S. Patent Application No. 2003/00888461, published May 8, 2003 and incorporated herein by reference, discloses a virtual couponing method and apparatus for use with a consumer kiosk. The consumer kiosk provides a means for consumers to obtain coupons electronically, at the entrance to the store. Targeting the consumer prior to the shopping experience provides an opportunity to present discounts to the consumer before they reach the checkout register and thus direct consumption and steer the consumer's shopping experience.

Relatively recent developments in retail shopping have expanded the possibilities and applications for consumer couponing. RFID (Radio Frequency Identification) devices are being implanted into products or attached to product packaging, to allow retailers to track inventories of products and also track individual products themselves. In addition, such technology is being implanted into credit cards, cellular phones and even patches (stickers) which may be attached to credit cards or other items. This technology allows a consumer to pay for purchases merely by being in proximity to an RFID type scanner, which can read a credit card number or other data from a card or from a cell phone or other device. Mobil Oil Corporation pioneered this technology over a decade ago with its speedpass and similar technology has been developed for use in cellular telephones and other devices.

This technology is not without its drawbacks and teething pains. One problem, of course, is if such devices are stolen. A stolen speedpass for example, can be used to buy gasoline or a whole host of products, before it is cancelled by the user. And a stolen cell phone or PDA could be a treasure trove for a thief, as it may contain account data as well as personal data, which may be useful for identity theft. In addition, some argue that sending such payment or customer identification signals via radio frequency (RF) channels will open them up to hacking by anyone within radio range.

Many so-called privacy advocates have argued that many uses of RFID type technology, could compromise an individual's privacy, by allowing a person to be tracked, electronically, through their cell phone or RFID-enabled credit card or other device. Similarly, other types of demographic or personal information harvesting systems are viewed by many consumers with suspicion, as the data exchange is often a one-way street. The consumer gives up rights to their private information, such as their identity and shopping habits, but received little in return, other than the opportunity to be marketed to. The consumer does not perceive such systems as providing any benefit to them, and in many cases, they are correct in that regard.

Such concerns are valid, and for many consumers, worrisome—which may explain why this technology has yet to gain widespread acceptance. Most consumers correctly view this technology as advantageous to retailers, but providing little benefit to themselves. Thus, a need exists in the marketplace to provide a system and method which takes advantage of these new technologies and provides benefits to both consumers and retailers, which in turn may make this type of technology more popular, cost-effective, and useful to both consumers and retailers.

As noted previously, the cellular telephone, in particular, so-called smart phones, such as the Apple™ iPhone™ and the Google™ Driod™ allow users to operate custom programs or applications (“apps”) on these devices, which are essentially hand-held networked computers. These types of devices have large color displays and can be used to display graphical data. As previously noted, the use of smart phones as credit-card like devices is being implemented. However, it remains a requirement in the art to integrate the use of such devices into an overall shopping experience. The wide area of app choices such as “GrocerylQ” does not directly target or direct the consumer to individual specific loyalty product discount offers.

Transferring money from one person to another often involves difficulty and bank fees. For many persons who do not have bank accounts, established addresses, and the like, trying to cash checks or receive money may be difficult or expensive. For example, migrant workers without roots in a particular area may find it difficult to cash a paycheck without resorting to the use of a check cashing service or the like, which may require a fee of $25 or more, simply to cash a check. Without proof of identification, it may be difficult to cash a paycheck even at the bank issuing the check. Moreover, many poor people and migrant workers distrust banks or do not have means to travel to bank branches that are not located near their area of employment or residence. The Prepaid loyalty kiosk offers this targeted audience the expanded convince of a national interchange prepaid card with targeted loyalty card discounts triggered at the kiosk.

So-called gift cards, have been the subject of some minor controversy in the past, as fees associated with such gift cards and the expiry of such gift cards have been criticized as disadvantageous to consumers. Gift cards are a revenue generator for merchants, as they often charge a fee for the gift card and in many cases, the gift cards are never redeemed, resulting in a pure profit scenario for the gift card issuer. In addition, even if a gift card is redeemed, since they are usually issued in even denominations (e.g., $50, $100 and the like), either the user will leave a small amount of money on the card unspent, or will spend more than the face value of the card, and thus the card encourages consumption.

Another criticism of gift cards has been fraud. In the past, criminals have scraped off the PIN numbers on gift cards on the rack, and then waited for someone to buy the card. Once purchased, the criminal can then use the gift card number (magnetically read while on the rack) and the PIN number (revealed by scraping off the protective coating) and then spend on the gift card. The purchaser of the card is then alarmed to discover that their $100 gift card contains only a few dollars of value.

For these and various other reasons, the gift card industry has repositioned the gift card as a prepaid “rewards card” and expanded the use of such cards to other applications. For example, prepaid rewards cards may be used for merchant credits for returned merchandise, or for loyalty rewards, for example, for 10 cents off on a gallon of gas after purchasing a certain amount of groceries.

However, concerns still exist as to security for prepaid rewards cards, and moreover, while the prepaid rewards card industry has been creative in finding new applications and uses for the old “gift card” the potential of the rewards card has not really been exploited.

Other kiosk devices are known in the art. For example, PSI corporation (http://www.psicoupons.com/) doing business as Pantel Systems, Inc. is a full service kiosk and digital signage company that specializes in the placement and management of coupon kiosks throughout the country. These kiosks come standard with the ability to process Coupons and provide loyalty enrolment cards for a loyalty program designed for specific stores.

The PSI kiosks provide consumers with information and functionality needed to redeem coupons for obtaining immediate discounts in store. Digital signage screens attached to the kiosks provide advertising opportunities for both national and local advertisers.

The PSI kiosks are placed in supermarkets and display promoted products on the Digital screen as well providing the ability to redeem coupons in order to purchase at a discounted rate. The system tracks the number of dispensed coupons and as well calculates the rebates that the store is due. The upper screen can be used as a tool to advertise store promotions and it has an interface allowing the local store to display and show special promotions. It receives its information from central servers that distributes the data to specific locations as require. The loyalty enrolment program and dispensing of loyalty cards is designed to automate the manual function provided by the store employees and allow the system to gather information on specific purchase trends.

As disclosed at http://www.gmtennis.com/start-up-narrate-offers-new-payment-technology-121393.html, there has been much discussion regarding NFC (Near Field Communication) which may be used for many kinds of digital applications and uses, most notably in payment methods. Although the technology is being developed by many companies, the devices will not be ready in the near future.

The Start-up company Narrate of Silicon Valley is attempting to fill this gap. The company's co-founder and chief development officer Byron Alsberg said that the widespread adoption of NFC is hampered by several hurdles that Zoosh—the name of the company's new payment technology—avoids.

Zoosh will be compatible for secure communication of smartphone-to-smartphone and smartphone-to-point of sale (POS) terminals. It makes use of audio signals, which may be generated and received by the smartphone's speakers and microphone, respectively. Using custom-made software that can be downloaded to a smartphone, Zoosh creates inaudible signal to transmit data between devices.

Other than the device-to-device app, Narrate also developed another device-to-POS app. This app may be used for payments. Another app also has been developed for loyalty programs. With this app, customers will be able to collect and redeem loyalty points.

The infrastructure of Zoosh will cost only $30 per POS. It will be in the form of a dongle plugged into the terminal. This is meant to add the necessary microphone and speaker capabilities. It will be capable for perishable transaction ID, which is unique for each shopping session.

### SUMMARY OF THE INVENTION

The present invention solves the problems of the Prior Art by providing a Point-of-Entry (POE) Kiosk prepaid loyalty system, couponing system, and shopping list system. When a consumer enters a store—be it a grocery store, warehouse store, retail store, or the like, one or more kiosks may be present for the consumer to use to initially check-in. The store may be configured to require the user to check-in, as many warehouse stores require, for example, to show proof of membership or identification. Alternately, the consumer may voluntarily check-in to determine whether there are any bargains targeted toward them, to transfer funds, download a shopping list, coupons, or the like. The consumer may be promoted by the kiosk, even by name, by detecting the presence of the consumer by means of RFID technology or from the consumer's cell phone, IVR, biometrics or the like.

Once at the kiosk or within proximity of the kiosk (as determined by the consumers RFID enabled cell phone, credit cards or the like) the consumer may log in cell phone number or be recognized Near Field Communication (NFC) RFID technology. The consumer can swipe a bar-coded or magnetically coded loyalty card, enter their loyalty number (phone number) or such data may be automatically entered through RFID technology or by means of the consumer's smart phone.

The consumer may then be presented with a number of discount or coupon offers or shopping suggestions, which may be based, in whole or part, on the consumer's prior preferences, demographic data, prior purchases, or other indicia (including preference data harvested from various social networking sites, search engines, or other websites used by the consumer). Such suggestions may be presented in coupon or list form, printed out, or may be downloaded/transferred to a digital device such as a smart phone, pad or tablet computer, or the like. A shopping list may also be generated, based on the consumer's prior purchases and shopping patterns, and also based on typical consumption patterns for the consumer (or historical consumption patterns of the consumer).

Thus, for example, if a consumer deposits a payroll check or purchases six rolls of paper towels during each store visit, and visits the store on the average of once a week, a simple computer algorithm can determine whether the consumer is running low on paper towels and then add that item to a suggested “shopping list” for the consumer. This technique can be used for many other staple items, from dog food, to milk, to coffee, to toilet paper, to just about anything. Since the system stores an historical record of consumer consumption, it can determine the consumer's consumption patterns of most, if not all staple (and even non-staple) items, and even adjust for seasonal use or the like. For example, holiday consumption may increase, and holiday items may be purchased at certain times of the year. The system of the present invention can remind the consumer of such items and advise them of availability of such items. This data can be modified based on typical consumption patterns, when no prior purchase history is present (e.g., consumer starts buying baby food).

In another embodiment, the entire process may be presented to the consumer in the form of an application or “app” for a smart phone such as the Apple™ iPhone™, Google™ Android™ or the like, or a PDA, tablet computer, or the like (“consumer device”). When the consumer enters the store, the location of the consumer can be determined from an RFID enabled device (or through a GPS tracking of a smart phone or the like, so enabled) and through the app, the shopping list and/or coupon or promotion list downloaded to the consumer device. The consumer may then be presented with a virtual shopping list, which may also have coupon or discount selections targeted to the consumer based on their demographic data and shopping history.

As the consumer selects each item from the shelf, it may be ticked off the list, either by scanning a bar code, or through RFID interaction with the device. The consumer device may also tell the consumer where to find certain items on the list, based on aisle number or even by giving directions (e.g., “10 paces ahead on the left”). Upon checkout, the consumer device may interact with a cash register or other checkout device to log the total of purchases made, and then debit the appropriate financial instrument (debit card, credit card, checking account, or the like). The consumer can then leave the store with the purchases, without having to take them out of the shopping cart to “check out”—thus eliminating a time-consuming chore.

The use of proximity detection technology, such as GPS or RFID may also be used to entice the consumer into the store. For example, a consumer may be driving past or near a store on their way home from work. An application on the consumer device may determine that the consumer is low on some supply or staple, and also realize that the consumer is within a short driving distance of the store. The application may indicate to the consumer, via text message, audio message or the like (e.g., over a Bluetooth interface through a vehicle audio system), and generate such a message over the consumers device, (e.g., “You are running low on one or more of the following items . . . ” and “The store is located one-half mile away, to your left.” Directions to the store may also be displayed on the vehicle's navigation system. Similarly, the application may indicate the availability of discounted items the consumer might like, and remind the consumer using audio signals such as, “Your favorite wine is on sale at Acme Wine Company, three tenths of a mile ahead on the right.” Similar technology may be used in indoor shopping malls or in cities, using RFID technology and the like, to sense when a consumer is walking by a store, to remind the consumer of shopping needs or advertise discounts of interest to the consumer.

These various applications for both Kiosk and consumer device use provide benefits to both the consumer and retailer, and thus do more than merely collect consumer demographic data to the advantage of the retailer. Consumers are understandably wary of programs and systems which harvest demographic or other data, and are reluctant to offer up such data, not only due to privacy concerns, but also because they do not perceive any benefit to themselves by providing access to such personal data. The system of the present invention solves this problem by providing services, which are of clear advantage and use to the individual consumer. As such, consumers may be more willing to use such technology as it enhances their lives, and will be looked upon as less of an invasion of privacy.

The primary purpose of the Point-of-Entry (POE) Kiosk Prepaid Loyalty System is to initiate contact with retail consumers at the point of entering various storefronts, and in-turn, make general and targeted one-to-one product discount offers. Using both contact and contactless devices, the Point-of-Entry Prepaid Kiosk System identifies the consumer in real-time and presents product and service offers prior to commencement of their shopping selections and activities. Contact may also be made at office/home computers initiating a shopping response and require POE contact for discounts and data collection.

Key to the success of the offers presented is the real-time integrated interactive Customer Relationship Marketing (CRM) database system that communicates offers using multiple touch based pads and wireless devices. Most consumers make thirty percent (30%) of retail purchases on impulse during their shopping activities while in the store. Various devices may be utilized to communicate specific offers to the consumer immediately at the Point-of-Entry (POE) or even at the Point-of-Sale (POS). A simple touch pad entry of the consumer's phone number or other identification number or code, may trigger a printed discount of offers or a contactless interaction via Radio Frequency Identification chips (RFID) which may identify a consumer and activate a cell phone text message, SMS or email or simply transfer data from kiosk to the contact smart phone. The system may operate in tandem with retailer's customer loyalty programs and generate discounts at the Point-of-Purchase (POP). To apply the discounts at the POS, mag-stripe, RFID, barcode scanning from the printed paper, cell phone displayed barcode, loyalty card swipe or phone number pin entry may all be applied during the consumer checkout.

The MerchantSellect CRM system database may automatically exchange/transfer purchasing data to a host system and between the retail chain loyalty database host server for the purpose of analysis and the generation of future one-to-one customer product specific discount offers. The Point-of-Entry Kiosk Loyalty System may create an immediate up-sell and cross-sell opportunity of goods and services, reducing marketing expenses and increasing average purchases resulting in improved marketing and advertising Return On Investments (ROI).

Different Point-of-Entry devices may be used, dependent on costs and functionality. The primary objective is to reach the lowest common denominator to capture the broadest consumer participation possible. This may, in conjunction, also achieve integration and flexibility to interact with current retailers POS systems and present day loyalty programs. Several approaches to integration with the consumer at the Point-of-Entry may be applied as follows.

In one embodiment, the POE device may comprise a consumer identification function utilizing a touch-screen phone number, mag-stripe reader, PIN pad or cell phone RFID contact. A real-time product discount response may be returned to the customer via a printed offer with a barcode, a loyalty card mag-stripe/barcode for scanning or cell phone barcode text message to be presented at the POS scanner during checkout to trigger personalized discounts. A cell phone may also trigger loyalty discounts using contactless RFID chips such as Near Field Communications (NFC) both in isle and at the POS lane. A Near Field Communication (NFC) sticker may comprise a chip embedded in a sticker that may be placed on a mobile phone or elsewhere and identify the user when using the kiosk. In fact, the user may be identified and a text message sent to cell phone just by passing near the kiosk. This may eliminate the need for plastic loyalty cards.

The POE system may operate in one or more of the following ways:
1. A customer may swipe a loyalty card and trigger a printout or cell phone text message of discounts for one-to-one personalized savings when swiping loyalty cards at the point of sale.
2. A PIN pad entered customer code using primarily the customer's phone number may trigger a personalized printout or cell phone text message for securing discounts at the POS during checkout
3. A kiosk RFID reader device may identify the customer upon entering the store and trigger a printout of discounts or send a cell phone text message of discounts and barcode to be scanned at POS checkout to secure personalized discounts.
4. A home/office based email may list discounts with a customer code to be entered into at POE kiosk or send a cell phone text to trigger discounts to be secured at the POS checkout.
5. RFID touch technology may allow Kiosk-presented discounts or information that is then transferred directly from the Kiosk to the Smart phone in real time without sending a text or cellular message.
6. Insurance Flex cars may be accepted and used to co-pay 80% of the over-the-counter drugs, for example, at a pharmacy POS check out.

In all cases, the customer may be able to participate using any or all of the POE contact interaction methods mentioned above. The universal database phone number key code may allow the shopper to utilize this approach to meet their personal interactive preferences regardless of their selection of contact device. Registration and contact information may be submitted and collected online at the MerchantSellect website.

A Point of Sale (POS) device may use a mag-stripe or barcode scanner presently available (e.g., Off the Shelf or OTS technology, which may already be present in the store) and may support the POE Kiosk System and allow for simple one-to-one integration with retailer loyalty discount programs at the POS. In this manner, the present invention can be quickly and easily implemented without requiring the retailer to invest in new POS equipment, at least initially. The kiosk system may also work in concert with RFID contactless devices that interact with the consumer cell phone and the retailer POS devices to automatically identify loyalty discounts and apply them at the POS.

The following are the various methods that may trigger the POS device to apply one-to-one loyalty product discounts at the POS:
1. PIN entry of phone number.
2. A loyalty card or key fob may be used at the checkout to apply discounted offers that were extended at the POE kiosk and applied at the POS.
3. A printed barcode present on a paper printout or transmitted to a cell phone may be scanned that may trigger discounts offer at the POE kiosk or printed from home or office.
4. A contactless RFID such as Near Field Communication (NFC) chip either transmitted from the cell phone or embedded in a loyalty card may trigger the POS device to apply one-to-one discounts at the point of checkout.

The POE Kiosk System may allow for a closed-loop marketing communications capability that ties the POE to the POS in real-time during a customer's shopping visit. A unique end-to-end process affords brand manufactures an opportunity to create a one-to-one marketing relationship while the consumer is in the store in real-time. The system may also trigger instant text messages about other discounts available to the shopper while in the retail store furthering additional Point-of-Purchase (POP) impulse buys.

The of Point-of-Entry Prepaid Kiosk Loyalty System may allow product manufacturers and retailers a on-to-one closed-loop real-time interaction process when marketing to their customers. The system is geared to appeal to a broad multi-generational consumer to reach the lowest common denominator resulting in the broadest appeal possible. This may be critical as the cell phone based younger generation appeal versus the older paper based consumer may both approach the Point-of-Entry Kiosk based on their personal preference. Traditional paper couponers as well as younger smart phone “app” users are both equally served.

This fundamental approach fully engages all consumers and seamlessly integrates into currently existing loyalty card programs most prevalent in the grocery industry. The system may be expanded to the contactless (e.g., RFID) environment as such equipment becomes part of the installed base of retailer hardware, and in accordance with the revenue base associated with the current in-place loyalty marketing programs/applications. The present invention thus allows for a logical transition for the manufacturer and retailer because it may maximize revenue and minimize the technical evolutionary costs associated with the future move to a more robust contactless populist.

The MerchantSellect Kiosk System incorporates both the young and older consumer universally. Engaging the consumer at the Point-of-Entry offers the advertiser the highest-level possible of increasing and capturing the potential impulse buy. In addition, it affords the manufacture and retailer to make specific one-to-one offerings in real-time. This is an important aspect at it relates to improving their overall ROI related marketing and advertising expenses. Their present loyalty program cannot achieve this because seventy (70) percent of consumer purchases are the result of brand loyal customers. Using the current loyalty based programs cause short-term profit loss in the attempt to create new brand loyal consumers. It may also afford the opportunity for manufacturers to cross-sell or up-sell based upon consumer purchasing history that will be generated from the analytics derived from the customer relationship marketing programs and real-time data reporting.

In another embodiment of the present invention, the kiosk may be provided with the ability to accept cash, prepaid debit cards, pay checks, personal or business checks, and credit cards.

For example, a temporary laborer may receive his pay for the week on a Prepaid Pay Card which may use award card technology to implement. As noted in the Background of the present application, oftentimes such laborers in the past would go to a Payday retail outlet and cash the paycheck and be charged 4-6% of face value as a check cashing fee. They then go to a grocery store and buy a money gram and pay utilities because they are unbanked (e.g., do not have a checking or savings account with a mainstream bank). Alternately, a laborer may receive a paycheck, which may be scanned in and the amount transferred to a debit card at the Kiosk. Or, the paycheck may be “virtual” and the debit card credited through the Kiosk when the laborer logs in.

With the kiosk system of the present invention, a user may swipe credit, debit, or pay (awards) cards or input cash and pay their bill electronically at the kiosk. This would act much like how many people pay bills online today and may use the same online bill pay service providers, interfaced with the Kiosk. When a user swipes their card they would select their account, which would have their personal utilities account info, at this point they would key enter the amount they want to pay the utility from the touch screen MerchantSellect kiosk. Alternately, they may scan a bar or other optical code from their utility bill (by way of example) which would then retrieve bill pay information. Alternately, their utilities account information may be set up online at a friend's computer, a public computer (e.g., public library) or even offered by their temporary staffing employer public employee office computer and the information sent to the MerchantSellect kiosk hosting server for storage and recall for the next time they want to pay bill or transfer funds home. Alternately, the kiosk may be provided with a keyboard to allow the user to input such information to set up their account and bill pay or money transfer information.

The kiosk may also accept cash and dispense a loaded debit card as well. The kiosk may do so by incorporating and interfacing with the MoneyGram MasterCard exchange or other type of debit card system.

Cash may be inserted and a loaded debit card dispensed. Alternately, a paycheck may be cashed online and funds transfer to kiosk for debit card dispensing. In yet another embodiment, a paycheck may be scanned into the device, and the data retrieved to perform an ACH debit or other electronic transfer function, to debit the payroll account by the amount due and then transfer the funds to the user in the form of a prepaid debit, credit, or awards card. The payroll money may also be directed to pay bills online, or to be transferred (e.g. wire transfer, MoneyGram, or the like) to other parties. The kiosk may also generate money orders based on the credits from the payroll check, and dispense cash or awards card for any balance left over and due.

In another embodiment of the present invention, the system of the present invention may be used to load a prepaid card from a remote Internet site through an ACH fund transfer. IN a preferred embodiment, a person's net paycheck is sent electronically to a kiosk, which in turn dispenses a General Purpose Reloadable (GPR) Visa prepaid card. A person may get his first GPR card from the kiosk by entering a personalized code and then reload the card every payday with his current paycheck amount, which is uploaded to the kiosk. Loading GPR cards now makes the transfer of funds possible from a credit card to a gift card, bill pay, money order, wire transfer, money gram or the like. Having an employee able to enter a code and swipe or insert the card with an ACH fund transfer to a kiosk is not presently available today.

Temporary Staffing Companies have a lot of unbanked employees (employees, which for one reason or another, do not have a primary banking relationship with any regular bank) and paper checks are very expensive. The present invention provides a solution for such unbanked employees, allowing them to receive their money, pay bills, and transfer funds, without having to pay onerous check cashing fees. The present invention may be used in many other forms such as to send funds to a college student that is unbanked. Approximately 25% of the US population is presently unbanked. Anywhere you have a remote unbanked person/employee funds could be transferred to a kiosk.

The check cashing aspect of the kiosk may either use a Micor brand check reader, which, when you pay by check, scans the check electronically and returns the check back to the customer, or may take a photos of the check in a manner similar to apps for the iPod or iPhone used today. Such techniques may be used to deposit a check at the kiosk then transfer the fund onto a prepaid card. The kiosk may also be provided with a phone system or electronic link for contacting MoneyGram from the kiosk. In addition, a bill scanner and or coin sorter may be added to accept cash and deposit it onto a prepaid card. A Money Gram prepaid card may also offer the dual purpose of also being utilized as a loyalty card at participating retailers.

Biometrics may be used to accurately confirm the person's ID who is depositing or transferring of funds, a figure print ID may also be incorporated. Strict ID required by the FED to avoid money laundering or transfer of funds to terrorist, and the kiosk may be designed to accept such identification, which may be scanned in. Once identification for a user is established and confirmed, a user access code and PIN number may be used to confirm ID or biometrics (e.g., iris scanning, fingerprints, or the like) may be used to confirm identification. The kiosk may be equipped with a camera, as many ATMs are, to photograph users to confirm identification and to aid law enforcement in tracking of criminals and to discourage fraud. In addition the debit card may also be used jointly as a loyalty card at retailers offering the MoneyGram kiosk.

The kiosk, as it relates to MoneyGram, may take a payroll or personal check and deposit it onto a prepaid card or cash and deposit it onto a prepaid card. The kiosk may also take a photo of the check and make the deposit as well. Once the card is dispensed from the kiosk a consumer may swipe the card and insert cash/check and the kiosk system may then load the same card over and over without dispensing a new card. The system thus uses the same card again and again, just like a checking account debit card. The card may also be used in concert with a loyalty program giving it a dual purpose. The kiosk may also act as a loyalty/prepaid card system all at the same time.

In a manner similar to the RedBox DVD distribution system, a user may also contact the kiosk from a home computer for fund transfers in another city. Thus, for example, a college student could go to the kiosk and swipe the card to load money sent from home by parents who made the transfer on their home computer or other device (e.g. smart phone or the like).

In general, however, the kiosk is the primary point-of-contact. Other features, including features of the Prior Art, may be incorporated into the kiosk features and functionality, which may be accessed after making contact with the kiosk. The Payroll Loyalty Kiosk of the present invention may be a stand-alone device, or may be combined with the MerchantSellect POE Kiosk previously described. Combining the two kiosk functionalities provides an opportunity to cross-market to users—encouraging in-store consumption by offering, for example, coupons or discounts to users. Alternately, services, such as money orders or bill payment may be offered for free, provided the user spend a certain amount at the store where the kiosk is located (much as many loyalty cards offer discounts on gas in exchange for purchasing groceries). Thus, an unbanked worker may find it advantageous to do all of their shopping in a particular store, as they avoid check-cashing fees of check cashing stores or money order fees and also have the convenience of one-stop shopping.

The user may contact with the kiosk to activate discounts, information, acknowledge in-store presence. In contrast, most kiosks today are almost entirely informational or service oriented. The MerchantSellect POE kiosk of the present invention, in contrast, is customer-centric via marketing, advertising and loyalty database driven. Prior art technologies such as 2-D barcode, GPS, RFID, loyalty database support, product location, and the like may be incorporated into the kiosk, with Just-In-Time contact and product offering while at the entrance of the retailer. Contact devices such as smart phones, RFID Chip cards, mag-stripe loyalty cards, barcode cards may all be used as kiosk contact devices. A central database is used to host to process, predict, assign discounts and Customer Relationship Marketing support and processing. The unique combination of individual prior art products and devices as well as innovations in the present invention are combined into a point-of-entry prepaid kiosk not present today.

The infrastructure of Zoosh and other developing technology may be incorporated into the MerchantSellect prepaid kiosk for use in identifying the consumer at the kiosk when attempting to transfer funds or dispensing a new prepaid card. The IVR identification function may be used to prevent fraud or money laundering. The IVR may be used to further ID a consumer. Biometrics may also be a kiosk identification option supported by the MerchantSellect host server. The discount/prepaid confirmation may be offered to the consumer after making contact with the Kiosk, and may be transferred to the consumer via real time text, SMS or email.

In addition, the present invention provides for one-to-one marketing while at the kiosk. Offers may also be displayed at the kiosk and transferred by “tapping” the smart phone thus transferring discounts from the kiosk to the cell phone. While coupon printing at the kiosk would be available this would eliminate the need to print coupons or prepaid deposit receipts.

The POE Wellness kiosk may offer the same technical features and functionality that the Retail POE kiosk provides, with additional features target to the hospitals, medical clinics, doctor offices and pharmacies. The recent Health Care Act has placed a larger burden on the medical provider to electronically track and store patient health information. A key factor is to shift more medical attention to preventative measures and screening to eradicate diseases in the earlier stages and subsequently reduce long term care and overall costs. As a result, the outdated paper-processing and record keeping is now required to be stored and transferred electronically for processing of both insurance and government acceptance of medical claims.

The cornerstone for storing of patient records is the various Patient Management Systems (PMS) available today for both hospitals and doctor visits alike. The PMS performs a multitude of activities such as scheduling visits, recording patient history, determining cost and unpaid balances, requesting insurance payments from the private insurer as well as from Medicare and Medicaid. The PMS tracks prescription activities ordered and prescribed, and automatically places the prescription order with the pharmacy. The POE Wellness Kiosk may work in conjunction with the PMS and be the initial point-of-contact with the patient upon entering the hospital, doctor office/clinic, and/or the pharmacy.

The POE Wellness Kiosk may act as a virtual front office receptionist. The patient may electronically swipe or cell phone tap and activate the kiosk using an insurance card with mag-stripe, chip, NFC, smart phone or the Wellness Plus Rewards card to check in. Required patient information and insurance related forms would be completed at the kiosk, updating the PMS system and then alerting the head office of the patient's check-in. Other general information would be offered to the patient at the kiosk from future doctor patient physical scheduling to newly released drugs available relative to the patient's medical records as well as the anticipated co-payment required for the visit, to general health related information. Based upon the patient's preferred method of payment, the kiosk may accept debit or credit card payment at this time, avoiding the delayed billing many doctors suffer through today waiting for the insurance co-pay portion of the treatment payment. Insurance Flex cars may be accepted at the kiosk and used to co-pay 80% of the doctor's fee.

The loyalty Retail POE kiosk may be placed at the pharmacy with the same features and functionality as the POE loyalty kiosk described above, and interact in real time with the medical kiosk described prior. In concert with the POE kiosk, the Wellness Plus Rewards loyalty card offers a multitude of marketing and advertising activities would be available as in any loyalty card program. However, beyond the basic loyalty discount programs, the POE kiosk may offer prescribed drug samples pre-approved by the doctor when picking up their prescriptions, prescription order status, prescription payment amount, and over-the-counter related drug discounts much the same as any loyalty card holder. In addition, drug interaction related information and other house hold related discounts would available within the pharmacy.

The use of multiple kiosks provides the ability to complete an entire medical process between multiple locations while also performing many medical record-keeping functions seamlessly and without interrupting the medical personnel or pharmacist from performing more key job-related requirements. It may also speed up the payment process and increase retail sales through the use of the Wellness Plus Rewards loyalty program. Data chips may be installed in the Wellness card with patient health records and past prescription history that would also help prevent potential negative drug interaction problems and adverse side effects. A turnkey hospital, doctor's office and pharmacy POE kiosk offers a 360 degree cross-informational maintenance and patient record updating not available today and seamlessly integrates patient activity into their Patient Management Systems.

Kiosks may be located at a hospital POE, a doctor's office, or at a pharmacy. At a pharmacy, the kiosk may be used to alert the pharmacy that patient is at store, and alert the patient to store savings and store promotions. In the doctor's office, the kiosk may be used to steer patients to a particular cooperating pharmacy, or provide competitive analysis of pricing for prescriptions at local pharmacies, as well as listing which pharmacies accept particular drug plans an insurance. Thus the kiosk can be used in a dual capacity and coexist and offer extended functionality working at concert at a pharmacy and at the doctor's office or hospital, as well as with the insurance company.

Doctor's offices and hospital admitting rooms typically use an intake questionnaire, which may ask what medication the patient is using, location of pain, level of pain on a scale of 1 to 10, and the like. The kiosk of the present invention can automate this service, and thus intake date directly into the patient's record files, for later display to a doctor or other medical professional, via portable tablet computer or the like. The intake questionnaire may be offered in multiple languages, and may use voice generation and recognition software to generate questions and accept patient input.

In addition, the kiosk may be used with remote diagnosis techniques, in areas that are not regularly served by doctors. For example, a patient may log into such a machine at a pharmacy or the like, describe his symptoms, and even provide health data—such as blood pressure or pulse, which may be taken by an attached cuff, or even EKG or other monitoring data. A doctor at a remote location may then be able to view such data and make recommendations as to treatment, or write prescriptions.

The health kiosk system may generate electronic reminders for medical appointments via SMS messaging, recorded phone call, and the like, to the user's phone or cell phone, or other electronic device.

The display on the kiosk may be provided as a 3D product presentation at the kiosk, or using hand-held smart phones, which are available in 3D. 3D displays at the kiosk touch screen may be useful in presenting product demonstration and sales videos to consumers. The kiosk may use 2D & 3D barcodes.

Tokenization may also be used as part payment/loyalty aspect of the kiosk. Tokenization is described, for example, in Tokenization Guidance: How to Reduce PCI Compliance Costs, published by Prime Factors, Inc. on Dec. 10, 2011, and incorporated herein by reference.

The kiosk systems of the present invention may utilizing social media to attract and initiate product purchase via the POE Kiosk. A social media box may be added to the kiosk to would encourage users to approach by being interested in friend's recommendations using the Facebook-like properties when making contact with the kiosk. For example, there are 30-million Facebook users that have given a “Like” preference to Coke Cola. A social media aspect to the Kiosk may provide a great Value Added feature that would further lift current and new product sales. A proprietary kiosk social media platform may also be developed that is tied to the loyalty card holder using the Facebook platform (or other social media platform, including but not limited to Google+, MySpace, Friendster, Twitter, and the like) which is an open environment for software developers.

This aspect of the kiosk could alert shoppers or leave a message. For example a user may leave a message to other friends visiting the kiosk, that they had bought Dr. Scholl's foot support pads and have had great release from back pain. A discount from a brand manufacture may be included and initiated based upon the social media recommendation/review. If, for example, a Dr. Scholl's Foot product is bought based upon social media recommendation, a referral discount could appear at the kiosk for the person placing the referral comment next time they approach the kiosk as an added “thank you” discount.

Shoppers that select a coupon may be added to the product info and further enhance the potential for another shopper to buy the product as well. A separate friends button could be part of the kiosk were people would check to see who in their social network visited the kiosk and what products they recommend. Thus, for example, if a consumer prints out or selects a coupon at the kiosk or on the smart phone, their preferred social media network “wall” may be posted with a “like” or “+” or other affirmation that they selected this promotion, thus alerting their friends to the bargain. Word-of-mouth remains one of the most powerful marketing tools, and using word-of-mouth in conjunction with social media enhances the effectiveness of the kiosk system.

### BRIEF DESCRIPTION OF THE DRAWINGS

FIG. 1 is a block diagram of one embodiment of the present invention.

FIG. 2 is a front view of a kiosk utilized in one embodiment of the present invention.

FIG. 3 is a block diagram of a second embodiment of the present invention.

FIG. 4 is a block diagram of a third embodiment of the present invention.

FIG. 5 is a block diagram of a fourth embodiment of the present invention.

### DETAILED DESCRIPTION OF THE INVENTION

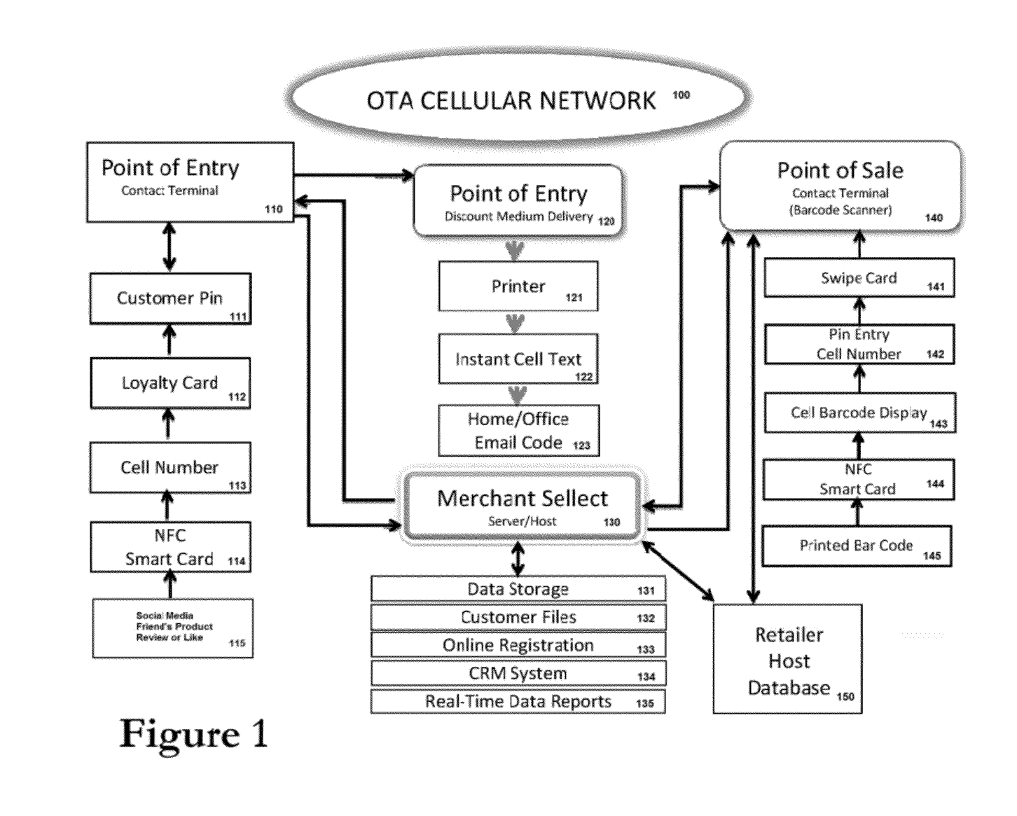

FIG. 1 is a block diagram of one embodiment of the present invention. Referring to FIG. 1, an over-the-air (OTA) cellular network 100 may be used to connect one or more of the components used in the present invention. Alternately, or in addition, to, landlines or other communications means (WiFi, Bluetooth, cable modem, DSL, fiber optic, or the like) may be used to communicate between the various elements of the present invention.

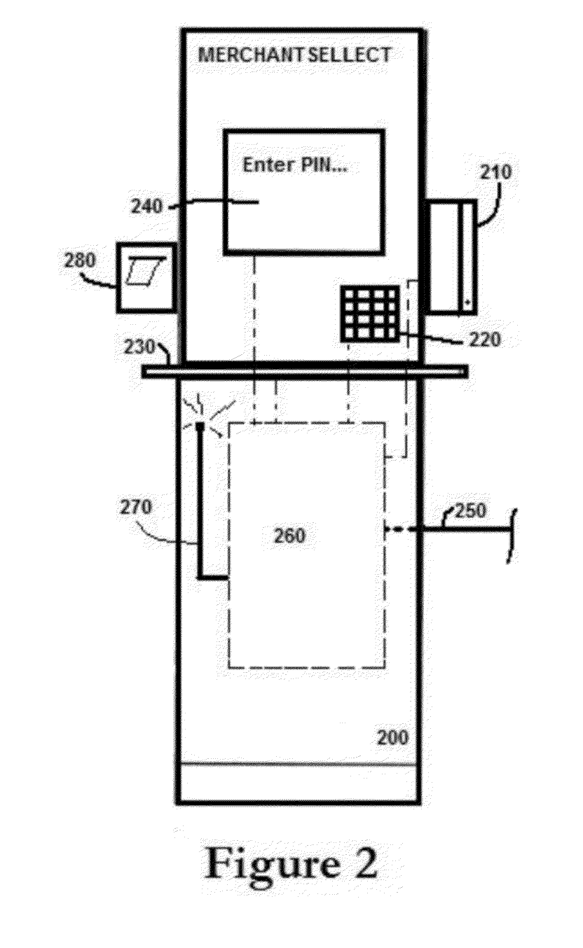

Referring to FIG. 1, The Point of Entry Contact Terminal 110, may receive an identification or log-in from a customer through one or more of a number of means. A customer may actively log in to the terminal using a loyalty card 112 (magnetically swiped or bar-code scanned) or by entering a loyalty number, which may comprise a cell phone number 113 or a customer PIN number 111, which may be entered through a PIN pad on the kiosk of FIG. 2. Alternatively, a Near Field Communication Smart Card, Sticker, or Smart Phone 114 may be used to communicate a customer identification to the Prepaid Kiosk Point of Entry Contact Terminal. RFID chips (not shown) or other identification means, may be used within the spirit and scope of the present invention.

As noted above, other methods of indicating the presence of a customer may be utilized as well. For example, an application (“app”) on a Smart Phone may indicate to the system (via a network) that a consumer is near the kiosk, by determining the consumer's position via GPS, cell-phone triangulation or multilateration, or other means. Once near the POE contact terminal, the consumer may receive a communication on their consumer device (e.g., smart phone, etc.) apprising them of discount offers, coupons, and shopping list items.

As illustrated in FIG. 1, the Point of Entry Discount Medium Delivery 120 may comprise one or more of a number of means. A printer 121 may be provided within the Kiosk of FIG. 2, to print out coupon offers, discounts, coupon bar codes, or shopping list items. Similar information may be sent to a consumer's smart phone as a text message 122 or displayed as an image on a smart phone display screen. In addition, such offers may be sent to a home or office e-mail address for printing 123.

Referring again to FIG. 1, the Point of Sale (POS) contact terminal 140 may include a barcode scanner or the like. This POS terminal may be located at the checkout stand, and may be part of a self-checkout operation, or part of a clerk-assisted checkout. Note that in some embodiments, the POE and POS contact terminals 110, 140 may be combined, so that a user can check-in at a POS terminal before shopping, or, if they have forgotten to check-in, do so at checkout and thus be prompted to perhaps shop more. Also, for smaller retail operations, a single kiosk may be used, where appropriate.

A bar coded loyalty card may be scanned in at this point, or a loyalty card 141 swiped, or a cell number (PIN number) 142 entered to identify the consumer, as in the Prior Art. In addition, a consumers smart phone display may display a bar code 143 which may be scanned, or a NFC smart card 144 or sticker 145 may be read by the POS device. RFID chips (not shown) or other identification means, may be used within the spirit and scope of the present invention. At the point of sale contact terminal 140, coupons printed from the Point of Entry contact terminal 110 may be scanned at this point and discounts applied to a consumer's total.

The MerchantSellect server/host 130 connects to the various elements of the system, including the POE contact terminal 110, the POE discount medium delivery 120, and the POS contact terminal 140. The MerchantSellect server/host 130 contains a data storage database 131 which includes customer files 132, online registration interface 133 (e.g., via internet, smart phone, or the like) the CRM system 134, and real-time data report generating capability 135 for generating demographic and sales data for retailer and wholesaler clients. The MerchantSellect server/host 130 may also interact with the retailer host database, which tracks sales data from the retailers POS terminal.

As noted previously, the MerchantSellect server/host may perform other functions, which may be of use to a consumer. For example, since the CRM system tracks individual consumer purchase data, and has access to vast amounts of consumer purchasing data on the Retailer Host Database, the system can generate shopping lists based upon a consumers usage patterns as noted above. These shopping lists or suggestions may be augmented by shopping list data entered by a consumer in his smart phone or the like or from home or office computers via the Internet. A consumer may also enter shopping list data online which would be added to a spouses shopping list, thus reminding a spouse to purchase an item on the way home from work. By combining all of this data in a seamless manner, the system generates a shopping list for people too busy to create shopping lists—which insures that their shopping experience will be optimized for both consumer and retailer.

Such shopping lists may also be augmented by discount or coupon offers to create an augmented list. A consumer may tick off items on the list and have such items assembled for them when they reach the retailer destination. The consumer's arrival time (ETA) can be readily determined from SmartPhone GPS positioning or other positioning techniques. Various staple items can then be selected, either manually or automatically, and placed into a cart, which may be electronically labeled for the consumer. The consumer may then devote the rest of their shopping experience to impulse purchases and suggested discount items, as staple purchases have already been made automatically.

Note that while the present invention illustrates the use of a kiosk or smart phone as an interface with the consumer, other types of devices, including smart carts (e.g., shopping carts with built-in displays and communications systems) may be used within the spirit and scope of the present invention.

FIG. 2 is a front view of a kiosk (Point of Entry Contact Terminal 110 of FIG. 1) 200 utilized in one embodiment of the present invention. Such a Kiosk 200 may be used to allow customers to log in, receive coupons, incentives, rebates, shopping lists, or the like. The POS terminal 140 of FIG. 1 may include similar elements, but may be integrated into a checkout terminal or cash register, including existing Prior Art registers and terminals and the like. For the sake of clarity, different reference numerals are used for corresponding elements in FIG. 2 than in FIG. 1, as FIG. 2 is a hardware diagram, while FIG. 1 is more of a block diagram and process diagram.

Such kiosks, in terms of hardware, are known in the art, for performing functions from banking (ATMs) to employment screening. The MerchantSellect Kiosk 200 may include a display screen, which may display messages and coupon offers and the like, as well as provide account balances and other information. A printer 280 may generate coupons, statements, and other information. A card reader or card swipe machine 210 may read magnetic cards, bar-coded cards, smart cards, or RFID encoded items. A keypad 220 and keyboard 230 may be used to accept manual user input data, and a point device (trackball, mouse, touch screen, or the like) may also be used. Alternately, a user may input data through their cell phone or smart phone, which may then be received by the kiosk 200, directly or indirectly.

Kiosk 200 may be include a processor and associated electronics 260 which drive the various elements of the device, and may be coupled to a network through a hardwire or fiber optic connection 250 or via wireless connection 270. Again, as noted, the physical hardware components are known to one of ordinary skill in the art. The present invention describes how these components can be arranged and used in a novel manner.

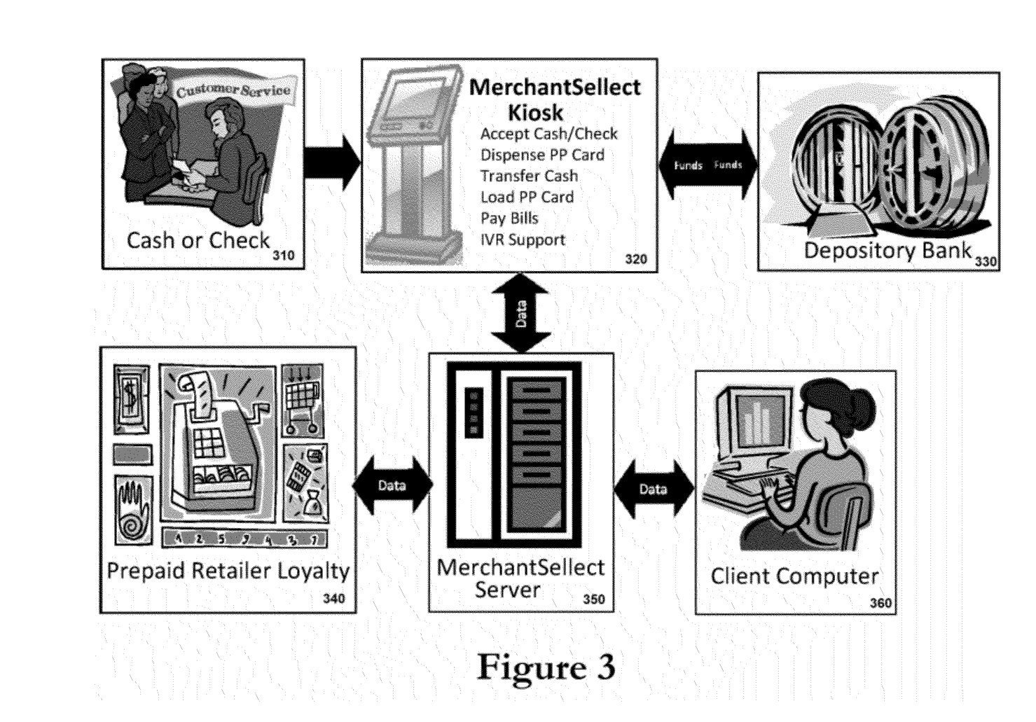

FIG. 3 is a block diagram of a second embodiment of the present invention, the Payroll Loyalty Kiosk. The Payroll-Loyalty Kiosk 320 may work in concert with the MerchantSellect POE Kiosk previously described, with different features and functionalities. Alternately, the Payroll Loyalty Kiosk may be combined with the MerchantSellect POE Kiosk into one unit. Referring to FIG. 3, the kiosk 320 may be specifically used as an alternative to live payroll checks and would function much the same as a checking account direct deposit network interchange debit card. The kiosk 320 may dispense either a general purpose reloadable prepaid or award cards. The card may be used for payroll, training and safety awards, bonus awards, and the like. The cards may be loaded in the kiosk 320 and would have value place upon it by a ACH transfer or via a cash receptor 310 that is built into the kiosk 320. The payroll card/award card may also be used as a loyalty card within an established retailer shopper loyalty program 340.

Many employers are frustrated and would like to migrate to a paperless payroll system. However, this is a bothersome process, as the employer has to insure that the associated with cards reach the correct employee. They often time get lost in the mail or there is an incomplete address like a missing apartment number and cards are then returned to the card issuer (bank). Or, an employer may hand out cards, which causes office personnel issues or the employee is unable to come into the office to obtain the original card. The Payroll/Award dispensing kiosk is a valuable tool for companies attempting to streamline their payroll process and eliminate paper payroll checks. The kiosk may be placed in the employers office and eliminate the need for payroll personnel handing out paychecks. Alternately, the kiosk may be placed in retail stores where the employee may visit, to obtain their pay, the cost of the kiosk being underwritten by the store, which will receive increased traffic as a result.

The Federal Automatic Clearing House (ACH) may accept a large wire transfer for the Payroll Card the same as they accept payroll for direct deposit into a personnel checking account. The funds 380 may then be transferred to a card-issuing bank 330 for transfer of funds onto a Payroll/Award card at the MerchantSellect kiosk 320. One can obviously recognize that this kiosk fund transfer may be used for multiple other purposes much like MoneyGram, as illustrated in FIG. 3.

The bank 330 may hold the funds 380 in abeyance until the kiosk 320 electronically contacts the funded account for transfer of funds and placement on the Payroll/Award card. The kiosk 320 may read the mag-stripe card number (or RFID chip, or smart card, or the like), record the card number and place the funds 380 onto the card and then dispense the card. The employee may have to go online via client computer 370, and set up his pay card establishing his user name and personal identification number (PIN) 390 prior to activating his card at the kiosk. This step may be performed, alternately by the employer, at a kiosk or computer located at the place of employment. The card issuance and activation generated at the kiosk 320 is then transferred and stored at the MerchantSellect Server 390 for multiple purposes as illustrated in FIG. 3. Data 350, 390 stored in the server may include account balances, lost or stolen card data, earned loyalty points, and the like.

The retailer may also use the kiosk 320 for dispensing money cards, which may also eliminate the paper money gram checks often offered at the service counter of a grocery or other types of retailers. An award card may also be used in place of gift cards. Any card dispensed from the kiosk 320 may also be used in the dual purpose of serving as a retailer loyalty card 340 independent of where the card was dispensed. The person may sign up for the card either online or at the kiosk automatically securing the person's information for loyalty program purposes. Coupon discounts may also be loaded on the card for brand manufacturer's promotions and redeemed during checkout after completing shopping. Swiping the card at the kiosk 320 may allow the holder to view what promotions are available during his visit to the store. Funds 380 may also be transferred onto the card from a Credit Card either at the kiosk or though a remote transfer to the kiosk.

One target audience for the kiosk, in addition to unbanked workers, is college students. Students often need to obtain money sent from home, and may not be physically close to a bank or ATM. Foreign ATMs may charge fees as high as $5 per transaction. A Kiosk on campus or at a store may provide a more convenient way to transfer funds. In addition, locating kiosks on college campuses will help spread acceptance of the kiosks among younger people, who will likely be upscale consumers in the future.

As illustrated in FIG. 3, the MerchantSellect server 360 may be the hub of a host of activities/services. A majority of those services are described in the MerchantSellect POE kiosk described above and in co-pending Provisional Patent Application Ser. No. 61/439,959, filed Feb. 7, 2011. Transferring and loading of funds remotely is one function that adds additional uniqueness to the kiosk, as well as the fact that a pay card may also have the dual functionality of being utilized as a retail loyalty card. The MerchantSellect server may also accept cash or credit for fund transfers onto an Award/Prepaid card. As in the original flow chart of FIG. 1, the MerchantSellect server may host CRM, databases, card authorization, and the like.

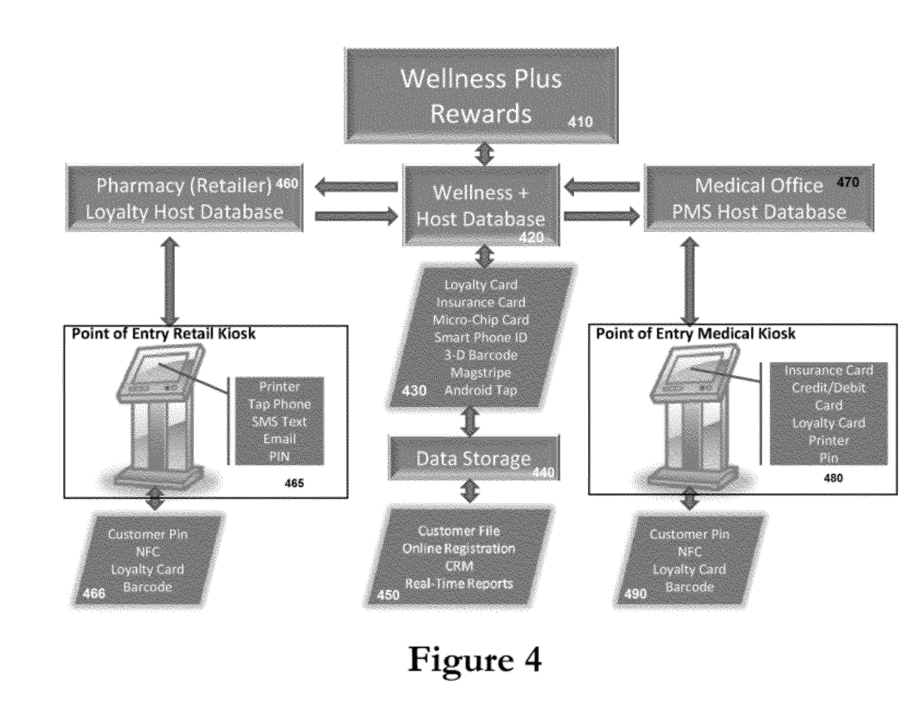

FIG. 4 is a block diagram of a third embodiment of the present invention. The POE Wellness 480 kiosk may offer some of the same technical features and functionality that the Retail POE kiosk 465, (similar to that of FIGS. 1 and 2) provides, with additional features target to the hospitals, medical clinics, doctor offices and pharmacies. The recent Health Care Act has placed a larger burden on the medical provider to electronically track and store patient health information. A key factor is to shift more medical attention to preventative measures and screening to eradicate diseases in the earlier stages and subsequently reduce long term care and overall costs. As a result, the outdated paper-processing and record keeping is now required to be stored and transferred electronically for processing of both insurance and government acceptance of medical claims.

The cornerstone for storing of patient records is the various Patient Management Systems (PMS) available today for both hospitals and doctor visits alike. The PMS and PMS database 470 performs a multitude of activities such as scheduling visits, recording patient history, determining cost and unpaid balances, requesting insurance payments from the private insurer as well as from Medicare and Medicaid. The PMS tracks prescription activities ordered and prescribed, and automatically places the prescription order with the pharmacy. The POE Wellness Kiosk may work in conjunction with the PMS and be the initial point-of-contact with the patient upon entering the hospital, doctor office/clinic, and/or the pharmacy.

The POE Wellness Kiosk 480 may act as a virtual front office receptionist. The patient may electronically swipe or cell phone tap and activate the kiosk using an insurance card with mag-stripe, chip, NFC, smart phone or the Wellness Plus Rewards card to check in as illustrated by block 490. Required patient information and insurance related forms would be completed at the kiosk, updating the PMS system database 470 and then alerting the head office of the patient's check-in. Other general information may be offered to the patient at the kiosk from future doctor patient physical scheduling to newly released drugs available relative to the patient's medical records as well as the anticipated co-payment required for the visit, to general health related information. Based upon the patient's preferred method of payment, the kiosk may accept debit or credit card payment at this time, avoiding the delayed billing many doctors suffer through today waiting for the insurance co-pay portion of the treatment payment.

The loyalty Retail POE kiosk 465 may be placed at the pharmacy with the same features and functionality as the POE loyalty kiosk described above, and interact in real-time with the medical kiosk 480 described prior. Customers may log in using one or more of a Customer PIN, Near Field Communications device (e.g., RFID or the like), a loyalty card, car code, smart phone, and other techniques as previously described and as indicated in block 466 in FIG. 4. The POE Retail Kiosk 465 may be coupled to a pharmacy database, which may include a customer loyalty program database, such as offered by major pharmacies.

In concert with the POE kiosk, the Wellness Plus Rewards loyalty card 410 offers a multitude of marketing and advertising activities available as in any loyalty card program. However, beyond the basic loyalty discount programs, the POE Retail Kiosk 465 may offer prescribed drug samples pre-approved by the doctor when picking up their prescriptions, prescription order status, prescription payment amount, and over-the-counter related drug discounts much the same as any loyalty card holder. In addition, drug interaction related information and other house hold related discounts would available within the pharmacy.

The POE Retail Kiosk 465 and the POE Medical Kiosk 480 may be coupled together through a network. Pharmacy retailer loyalty host database 460 may be coupled to the medical office PMS host database 470 via a wellness and hose database 420, which may coordinate the two databases and transmit data between the two. This database may contain user information which may be accessed through the use of loyalty card data, insurance card data, micro-chip date, smart phone Ids, 3-D barcodes, magnetic strip cars, or a smart phone Android™ tap, as illustrated in block 430. Such data may be stored in database 440 and may be received from customer files, online registration, Consumer Relationship Marketing, or real-time reports, as indicated in block 450. The Wellness and host database 420 may be coupled to the Wellness Plus Rewards database 410, to provide data for the overall system, as well as a packaged rewards program.

The use of multiple kiosks provides the ability to complete an entire medical process between multiple locations while also performing many medical record-keeping functions seamlessly and without interrupting the medical personnel or pharmacist from performing more key job-related requirements. It may also speed up the payment process and increase retail sales through the use of the Wellness Plus Rewards loyalty program 410. Data chips may be installed in the Wellness card with patient health records and past prescription history that would also help prevent potential negative drug interaction problems and adverse side effects. A turnkey hospital, doctor's office and pharmacy POE kiosk system offers a 360 degree cross-informational maintenance and patient record updating not available today and seamlessly integrates patient activity into their Patient Management Systems.

Kiosks may be located at a hospital POE, a doctor's office, or at a pharmacy. At a pharmacy, the kiosk 465 may be used to alert the pharmacy that patient is at store, and alert the patient to store savings and store promotions. In the doctor's office, the kiosk 480 may be used to steer patients to a particular cooperating pharmacy, or provide competitive analysis of pricing for prescriptions at local pharmacies, as well as listing, which pharmacies accept particular drug plans an insurance. Thus the kiosk can be used in a dual capacity and coexist and offer extended functionality working at concert at a pharmacy and at the doctor's office or hospital, as well as with the insurance company.

Doctor's offices and hospital admitting rooms typically use an intake questionnaire, which may ask what medication the patient is using, location of pain, level of pain on a scale of 1 to 10, and the like. The kiosk of the present invention can automate this service, and thus intake date directly into the patient's record files, for later display to a doctor or other medical professional, via portable tablet computer or the like. The intake questionnaire may be offered in multiple languages, and may use voice generation and recognition software to generate questions and accept patient input.

In addition, the kiosk may be used with remote diagnosis techniques, in areas that are not regularly served by doctors. For example, a patient may log into such a machine at a pharmacy or the like, describe his symptoms, and even provide health data—such as blood pressure or pulse, which may be taken by an attached cuff, or even EKG or other monitoring data. A doctor at a remote location may then be able to view such data and make recommendations as to treatment, or write prescriptions.

The health kiosk system may generate electronic reminders for medical appointments via SMS messaging, recorded phone call, and the like, to the user's phone or cell phone, or other electronic device.

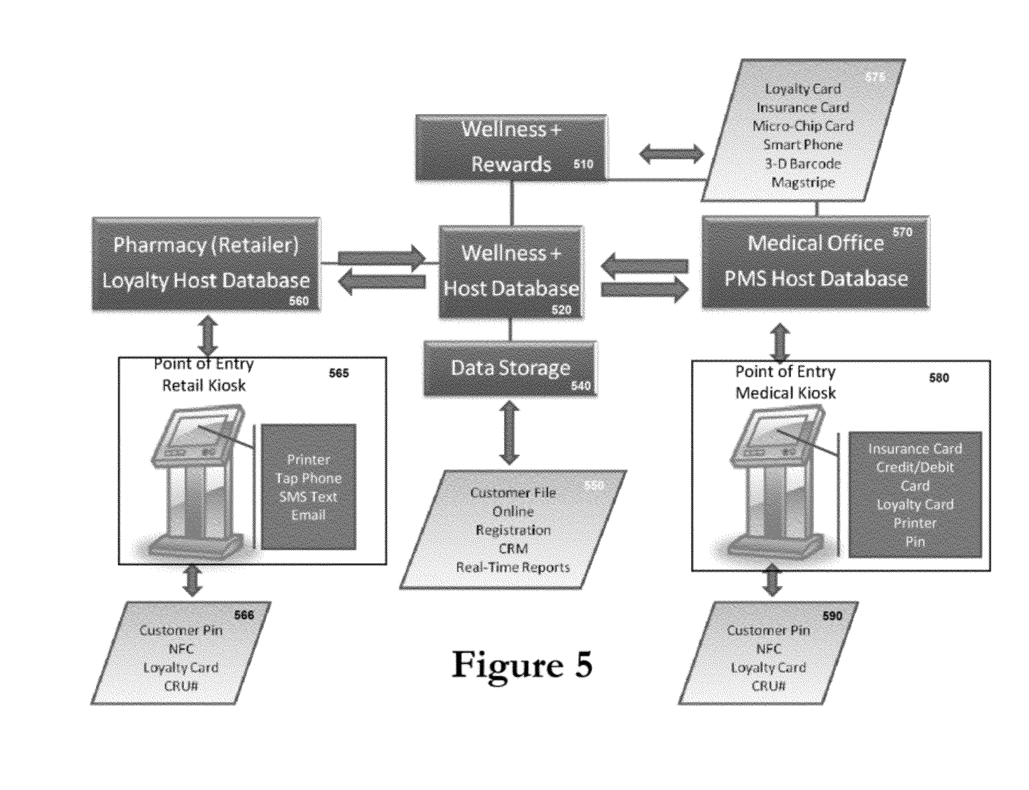

FIG. 5 is a block diagram of a fourth embodiment of the present invention. The embodiment of FIG. 5 represents an alternative embodiment of the system of FIG. 4, with the components arranged in a more simplified manner. The POE Wellness Kiosk 580 may act as a virtual front office receptionist. The patient may electronically swipe or cell phone tap and activate the kiosk using an insurance card with mag-stripe, chip, NFC, smart phone or the Wellness Plus Rewards card to check in as illustrated by block 590. Required patient information and insurance related forms would be completed at the kiosk, updating the PMS system database 570 and then alerting the head office of the patient's check-in. Other general information may be offered to the patient at the kiosk from future doctor patient physical scheduling to newly released drugs available relative to the patient's medical records as well as the anticipated co-payment required for the visit, to general health related information. Based upon the patient's preferred method of payment, the kiosk may accept debit or credit card payment at this time, avoiding the delayed billing many doctors suffer through today waiting for the insurance co-pay portion of the treatment payment.

The loyalty Retail POE kiosk 565 may be placed at the pharmacy with the same features and functionality as the POE loyalty kiosk described above, and interact in real-time with the medical kiosk 580 described prior. Customers may log in using one or more of a Customer PIN, Near Field Communications device (e.g., RFID or the like), a loyalty card, car code, smart phone, and other techniques as previously described and as indicated in block 566 in FIG. 5. The POE Retail Kiosk 565 may be coupled to a pharmacy database, which may include a customer loyalty program database, such as offered by major pharmacies.

In concert with the POE kiosk, the Wellness Plus Rewards loyalty card 510 offers a multitude of marketing and advertising activities available as in any loyalty card program. However, beyond the basic loyalty discount programs, the POE Retail Kiosk 565 may offer prescribed drug samples pre-approved by the doctor when picking up their prescriptions, prescription order status, prescription payment amount, and over-the-counter related drug discounts much the same as any loyalty card holder. In addition, drug interaction related information and other house hold related discounts would available within the pharmacy.

The POE Retail Kiosk 565 and the POE Medical Kiosk 580 may be coupled together through a network. Pharmacy retailer loyalty host database 560 may be coupled to the medical office PMS host database 570 via a wellness and hose database 520, which may coordinate the two databases and transmit data between the two. In the embodiment of FIG. 5, the Wellness Rewards database 510 and PMS host database 570 may both contain user information which may be accessed through the use of loyalty card data, insurance card data, micro-chip date, smart phone Ids, 3-D barcodes, magnetic strip cars, or a smart phone Android™ tap, as illustrated in block 575. Such data may be stored in database 540 and may be received from customer files, online registration, Consumer Relationship Marketing, or real-time reports, as indicated in block 550. The Wellness and host database 520 may be coupled to the Wellness Plus Rewards database 510, to provide data for the overall system, as well as a packaged rewards program.

There are a number of alternative embodiments of the present invention, in addition to the previously discussed embodiments. These alternative features may be incorporated into the various embodiments previously discussed. For example, the display on the kiosk may be provided as a 3D product presentation at the kiosk, or using hand-held smart phones, which are available in 3D. 3D displays at the kiosk touch screen may be useful in presenting product demonstration and sales videos to consumers. The kiosk may use 2D & 3D barcodes.

Tokenization may also be used as part payment/loyalty aspect of the kiosk. Tokenization is described, for example, in Tokenization Guidance: How to Reduce PCI Compliance Costs, published by Prime Factors, Inc. on Dec. 10, 2011, and incorporated herein by reference.

The kiosk systems of the present invention may also utilize social media to attract and initiate product purchase via the POE Kiosk. A social media box may be added to the kiosk to would encourage users to approach by being interested in friend's recommendations using the Facebook-like properties when making contact with the kiosk. For example, there are 30-million Facebook users that have given a “Like” preference to Coke Cola. A social media aspect to the Kiosk may provide a great Value Added feature that would further lift current and new product sales. A proprietary kiosk social media platform may also be developed that is tied to the loyalty card holder using the Facebook platform (or other social media platform, including but not limited to Google+, MySpace, Friendster, Twitter, and the like) which is an open environment for software developers.

Referring back to FIG. 1, block 115 illustrates how a Social Media product review, “like” or other affiliation may be used in the Kiosk of the present invention. Note that this feature may be applied to the Kiosks of all of the embodiments of the present invention. This aspect of the kiosk could alert shoppers or leave a message. For example a user may leave a message to other friends visiting the kiosk, that they had bought Dr. Scholl's foot support pads and have had great release from back pain. A discount from a brand manufacture may be included and initiated based upon the social media recommendation/review.

Shoppers that select a coupon may be added to the product info and further enhance the potential for another shopper to buy the product as well. A separate friends button could be part of the kiosk were people would check to see who in their social network visited the kiosk and what products they recommend. Thus, for example, if a consumer prints out or selects a coupon at the kiosk or on the smart phone, their preferred social media network “wall” may be posted with a “like” or “+” or other affirmation that they selected this promotion, thus alerting their friends to the bargain. Word-of-mouth remains one of the most powerful marketing tools, and using word-of-mouth in conjunction with social media enhances the effectiveness of the kiosk system.

The present invention may be combined with other Prior Art systems to enhance such systems and provide an improvement thereof. For example, some grocery stores are experimenting with self-checkout, while you shop, where a hand-held wide area network (WAN) device and/or smart phone may be used to allow shoppers to swipe their card on the device and then scan and pay for their groceries in the aisles and thus not go through a traditional checkout lane. The consumer just walks out the door when they are done shopping, as their groceries are already been paid for. The present invention may be applied to such systems by providing an app for a smart phone with an attachable credit card swipe machine (which is already available, for example, for the iPad or iPhone). Alternately, the smart phone itself may be tied to a credit card or other payment mechanism, to debit the customer's account when they purchase items in the store, using the smart phone. The cell phone may then swipe/scan item(s) barcode in the isle (or read RFID chips or the like) and be paid for via the smart phone thus eliminating the need for a separate WAN device. This app also loads information by tapping the cell phone at the kiosk, to load coupons/discounts, thus further alerting the customer to discounts while in the store shopping aisle using the smart phone for the Point-of-Purchase (in the aisle) cell phone check out app.

Similarly, the kiosk of the present invention may be used in conjunction for advertising features in social networking sites, such as Facebook or Google+. For example, a major advertising dilemma for selling ads using Facebook via “like or Facebook “share” with advertisers is the privacy issues. By taking this Facebook user posted information and using it for product advertising without Facebook subscribers' permission is arguably an invasion of privacy. In one embodiment of the present invention, the kiosk of the present invention may be used in concert with a loyalty program. When a customer is reviewing ads or products at the kiosk, they will also see a friend(s) “like” or “share” comments or referrals within the shopper's Facebook or Google+ (or other social networking site) social circle.

The card holder (consumer) as part of the terms of service (TOS) has agreed to this being posted, and is motivated to do so, as in exchange, they will earn referral points/rewards if the product is then purchased at the POS. The same principle may be applied at the Point of Purchase, or POP (in aisle) when a shopper passes a product and the smart phone alerts the consumer that, for example, a Facebook friend “likes” this product, thus enhancing the impulse buy. Again, word-of-mouth or referral by friends is a powerful marketing tool, and the present invention allows this tool to be turned to an electronic system which harvests this power and provides a standardized method of accumulating and distributing this data.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A system for marketing to consumers, comprising:
at least one database, containing consumer identification information and corresponding consumer promotional information; and
a kiosk, located in a store, allowing a consumer to log in to receive promotional discounts, the kiosk including:
a consumer input device, for receiving consumer identification information from the consumer to identify the consumer;
a processor, coupled to the consumer log-in device, for receiving the consumer identification information;
a communications link, coupled to the processor, for communicating with the at least one database to receive promotional information based on the consumer identification and downloading the promotional information to the processor;
a display, coupled to the processor, for displaying the promotional information to the consumer; and
an output device, for outputting the promotional information to the consumer.

2. The system of claim 1, wherein the consumer input device comprises one or more of:
a keypad or keyboard for accepting one or more of a consumer PIN, phone number, loyalty rewards number, or consumer identification number;
a magnetic card reader, for reading and encoding a magnetic card;
a bar code reader for reading a bar code of a consumer loyalty card;
a RFID reader, for reading an RFID chip; and
a radio receiver, for receiving a radio signal from a cell phone.

3. The system of claim 2, wherein the consumer input device accepts consumer input selecting at least one of a coupon, promotion, loyalty reward, or discount, and the processor communicates with the at least one database to indicate which of the at least one of a coupon, promotion, loyalty reward, or discount has been selected by the consumer.

4. The system of claim 1, further comprising:
a point-of-sale terminal coupled to the at least one database and the kiosk, communicating with the at least one database to retrieve the at least one of a coupon, promotion, loyalty reward, or discount selected by the consumer, and for applying the at least one of a coupon, promotion, loyalty reward, or discount to a customer's purchase.

5. The system of claim 4, wherein the point-of-sale terminal comprises:
a consumer input device, for receiving consumer identification information from the consumer to identify the consumer;
a processor, coupled to the consumer input device, for receiving the consumer identification information;
a communications link, coupled to the processor, for communicating with the at least one database to the at least one of a coupon, promotion, loyalty reward, or discount selected by the consumer, as stored in the at least one database.

6. A system for paying unbanked workers, comprising:
at least one database, containing worker identification information and corresponding worker pay information; and
a kiosk allowing a worker to log in to receive work pay and promotional discounts, the kiosk including:
a worker input device, for receiving worker identification information from the worker to identify the worker;
a processor, coupled to the worker log-in device, for receiving the worker identification information;
a communications link, coupled to the processor, for communicating with the at least one database to receive worker pay and promotional information based on the worker identification and downloading the worker pay and promotional information to the processor;
a display, coupled to the processor, for displaying the worker pay and promotional information to the worker; and
an output device, for outputting the worker pay and promotional information to the worker.

7. The system of claim 6, wherein the worker input device comprises one or more of:
a keypad or keyboard for accepting one or more of a worker PIN, phone number, loyalty rewards number, or worker identification number;
a magnetic card reader, for reading and encoding a magnetic card;
a bar code reader for reading a bar code of a worker loyalty card;
a RFID reader, for reading an RFID chip;
a scanner, for accepting checks; and
a radio receiver, for receiving a radio signal from a cell phone.

8. The system of claim 7, wherein the output device further includes a dispenser for at least one of dispensing and authorizing at least one or more of loyalty cards, rewards cards, gift cards, and pre-paid debit cards to the worker.

9. The system of claim 7, wherein the worker input device accepts worker input, in the form of worker identification, retrieves, over the communication link, worker pay information corresponding to the workers, and at least one of dispensing and authorizing at least one or more of loyalty cards, rewards cards, gift cards, and pre-paid debit cards to the worker in the amount of the worker's work pay.

10. The system of claim 6, wherein:
the worker input device accepts worker payment input directing payments made to one or more payees;
the communications link transmits the worker payment input to the at least one database;
the database debits the worker payment from the worker pay corresponding to the worker, in the database, and directs a corresponding payment to the payee.

11. A health information system for patient health information, comprising:
at least one database, containing patient identification information and corresponding patient health information; and
a point of entry medical kiosk allowing a patient to log in to enter patient identification data, and one or more of health history data, health questionnaire data, and patient presence information, the kiosk including:
a patient input device, for receiving patient identification information from the patient to identify the patient;
a processor, coupled to the patient log-in device, for receiving the patient identification data and one or more of health history data, health questionnaire data, and patient presence information;
a communications link, coupled to the processor, for communicating with the at least one database to receive patient health information and based on the patient identification and downloading the patient health information to the processor;
a display, coupled to the processor, for displaying the patient health information to the patient; and
an output device, for outputting the patient health information to the patient.

12. The system of claim 11, wherein the patient input device comprises one or more of:
a keypad or keyboard for accepting one or more of a patient PIN, phone number, loyalty rewards number, or patient identification number;
a magnetic card reader, for reading and encoding a magnetic card;
a bar code reader for reading a bar code of a patient loyalty card;
a RFID reader, for reading an RFID chip;
a scanner, for accepting checks; and
a radio receiver, for receiving a radio signal from a cell phone.

13. The system of claim 12, wherein the at least one database transmits the one or more of health history data, health questionnaire data, and patient presence information to a care giver.

14. The system of claim 11, wherein the at least one database includes a caregiver database including patient medical history, diagnoses, and prescription information.

15. The system of claim 14, further comprising:
a point of entry retail kiosk allowing a patient to log in to enter patient identification data and retrieve patient promotional data, the kiosk including:
a patient input device, for receiving patient identification information from the patient to identify the patient;
a processor, coupled to the patient log-in device, for receiving the patient identification data;
a communications link, coupled to the processor, for communicating with the at least one database to receive patient promotional data and downloading the patient promotional data to the processor;
a display, coupled to the processor, for displaying the patient promotional information to the patient; and
an output device, for outputting the patient promotional information to the patient.

16. The system of claim 15, wherein the patient input device in the point of entry retail kiosk accepts consumer input selecting at least one of a coupon, promotion, loyalty reward, or discount, and the processor in the point of entry retail kiosk communicates with the at least one database to indicate which of the at least one of a coupon, promotion, loyalty reward, or discount has been selected by the consumer.

17. The system of claim 16, further comprising:
a point-of-sale terminal coupled to the at least one database and the point of entry retail kiosk, communicating with the at least one database to retrieve the at least one of a coupon, promotion, loyalty reward, or discount selected by the consumer, and for applying the at least one of a coupon, promotion, loyalty reward, or discount to a customer's purchase

18. The system of claim 1, further comprising:
a social network interface, coupled to the kiosk, interfacing, through the communications like, to at least one of send and retrieve social network product affirmation information;
wherein the at least one database further comprises a social network database for storing consumer social network identification information and consumer product affirmation information;
wherein the processor retrieves, from the social network database, using the consumer identification information, consumer product affirmation information associated with other consumers affiliated with the consumer through the social network; and
wherein the processor displays product affirmation information to the consumer.

19. The system of claim 18, further comprising:
wherein the consumer input device accepts consumer input of one or more of product affirmation information and product purchase information; and
the processor uploads the one or more of product affirmation information and product purchase information through the communications link to the social media database for display to consumers affiliated with the consumer through the social network.

20. The system of claim 5, wherein the point of sale terminal further comprises:
a social network interface, coupled to the kiosk, interfacing, through the communications like, to send social network product affirmation information;
wherein the at least one database further comprises a social network database for storing consumer social network identification information and consumer product affirmation information;
wherein the consumer input device accepts input of product purchase information; and
the processor uploads the product purchase information through the communications link to the social media database for display to consumers affiliated with the consumer through the social network.
